(19) United States
(12) Patent Application Publication
(10) Pub. No.: US 2026/0362126 A1
(43) Pub. Date: Nov. 12, 2026

(54) SNN FOR SECURITY KEYS IN UE-TO-NETWORK RELAY

(71) Applicant: TELEFONAKTIEBOLAGET LM ERICSSON (PUBL), STOCKHOLM (SE)

(72) Inventor: Cheng Wang, Shanghai (CN)

(21) Appl. No.: 19/129,893

(22) PCT Filed: Nov. 13, 2023
(86) PCT No.: PCT/IB2023/061446

§ 371 Date: May 14, 2025

(30) Foreign Application Priority Data
Nov. 14, 2022 (WO) PCT/CN2022/131644

(51) Int. Cl. H04W 12/041; H04W 12/06; H04W 76/14

(52) U.S. Cl. CPC H04W 12/041; H04W 12/06; H04W 76/14

(57) ABSTRACT

The present disclosure proposes a method and system to determine the Serving Network Name (SNN) value which is used for Proximity Services (ProSe) authentication. In a first embodiment, the remote User Equipment (UE) and home network of the remote UE determine to use a fix value SNN for ProSe authentication, e.g., “5G:Prose”. Thus, regardless of which relay UE is discovered by the remote UE, the ProSe authentication vector can be generated. In another embodiment, the Remote UE can derive the SNN from the cell info of the relay UE from discovery procedure. In yet another embodiment, a Relay UE sends the SNN of the relay network to Remote UE as part of ProSe authentication procedure. This allows security keys to be generated for PC5 communication, based on the common value of SNN in the network side and UE side.

### RELATED APPLICATIONS

This application claims the benefit of international patent application serial number PCT/CN2022/131644, filed Nov. 14, 2022, the disclosure of which is hereby incorporated herein by reference in its entirety.

### TECHNICAL FIELD

The present disclosure relates to methods and systems for determining a Serving Network Name for security keys for User Equipment (UE)-to-Network Relay in a wireless communication system.

### BACKGROUND

### Security Procedure for UE-to-Network Relay

A Fifth Generation (5G) Proximity Service (ProSe) User Equipment (UE)-to-Network Relay is a (5G ProSe-enabled) UE that provides functionality to support connectivity to the network for 5G ProSe Remote UE(s).

Technical Specification (TS) 33.503 defines the procedure of Security for 5G ProSe Communication via 5G ProSe Layer-3 UE to-Network Relay, with two methods i.e., user-plane (UP) based and control-plane (CP) based procedures.

Both can be used for 5G ProSe UE-to-Network Relay authorization and security establishment in a PC5 interface. The UP based procedure uses a UP connection to the ProSe Key Management Function (PKMF) in the 5G Core Network (5GC), while the CP-based procedure uses the ProSe authentication vehicle over the Non-Access Stratum (NAS) procedure towards an Access and Mobility Management Function (AMF), and Authentication Server Function (AUSF) in the 5GC.

High level flow of security for UE-to-Network Relay is shown in FIGS. 1 and 2. In FIG. 1, which illustrates a Reference Architecture for 5G ProSe Layer 3 UE-to-Network Relay, a remote UE 102 connects to a 5G core network 108 via a radio access network 106 via a relay UE 104. FIG. 2 illustrates a High level flow of security for UE-to-Network Relay and in particular, the authorization and secure PC5 link establishment procedure for 5G ProSe UE-to-Network Relay for a user plane based solution.

### Serving Network Name for AKA Security Keys

Security materials in 5GC are expected to be bound with a specific serving network name e.g., serving network Public Land Mobile Network (PLMN) Identifier (ID) where the UE is registered. For example:
Cipher Key (CK′) and integrity key (IK′) for Extensible Authentication Protocol Authentication and Key Agreement (EAP-AKA′) are derived from EAP-AKA′ authentication vector (AV) (CK, IK) and the serving network name (cf Annex A.3 33.501),
Authentication Response (RES*) and Expected Authentication Response (XRES*) are derived from RES and XRES and the serving network name (cf Annex A.4 33.501),
KAUSF, and KSEAF are also bound to the serving network name (cf Annex A.2/A.4 33.501).

### Information from Discovery Procedure for UE-to-Network Relay

Third Generation Partnership Project (3GPP) also specifies the discovery procedure for how the Remote UE and Relay UE can find each other, and the information associated with UE. As per TS23.304, the information can be discovered include:

```
**BEGIN TS23.304 QUOTE*
The following parameters may be used in the Relay Discovery Additional Information message (for Model A)
based on the procedure defined in clause 6.5.1.3 for 5G ProSe UE-to-Network Relay where Source Layer-2 ID
and Destination Layer-2 ID are used for sending and receiving the message, and the other parameters are
contained in the message:
  - Source Layer-2 ID: the 5G ProSe UE-to-Network Relay self-selects a Source Layer-2 ID to send the
    Relay Discovery Additional Information message.
  - Destination Layer-2 ID: the Destination Layer-2 ID to send the Relay Discovery Additional Information
    message is selected based on the configuration as described in clause 5.1.4.1.
  - Relay Service Code: the Relay Service Code associated with the message. The Relay Service Code is used
    to identify the security parameters needed by the receiving UE to process the discovery message.
  - Announcer Info: provides information about the announcing user.
  - Additional parameters: the additional parameters for 5G ProSe Layer-3 UE-to-Network Relay (when
    applicable) are defined in clause 5.8.3.2.
**END TS23.304 QUOTE
```

Wherein the additional parameters refer to:
The following additional parameters may be used in the Relay Discovery Additional Information message (for Model A) for 5G ProSe Layer-3 UE-to-Network Relay:
   NCGI (NR Cell Global ID): indicates the NCGI of the serving cell of the 5G ProSe Layer-3 UE-to-Network Relay. This parameter may be requested by application running on 5G ProSe Layer-3 Remote UE.
   TAI (Tracking Area Identity): indicates the Tracking Area Identity of the serving cell of the 5G ProSe Layer-3 UE-to-Network Relay. This parameter may be used by 5G ProSe Layer-3 Remote UE to select a N3IWF.

I.e., Remote UE can send Relay Discovery Additional Information message to learn the cell info where the Relay UE camps.

Where New Radio (NR) Cell Global Identity (NCGI) is composed of the concatenation of the PLMN Identifier (PLMN-Id) and the NR Cell Identity (NCI).

The Tracking Area Identity (TAI) consists of a Mobile Country Code (MCC), Mobile Network Code (MNC), and Tracking Area Code (TAC).

It has been identified in 3GPP that in Prose CP based solution when an authentication vector (AV) is generated for Prose authentication of the remote UE in UDM, SNN (serving network name) is used for authentication vector generation in the network side, e.g. to generate CK′ IK′ of EAP AKA AV′ (RAND, AUTN, XRES, CK′, IK′), cf. clause 6.1.3.1 of TS33.501.

However, since the Remote UE is not registering to 5GS in this case, it is unknown what the serving network and its name should be used for the remote UE in Prose authentication.

There has been a proposal to use the Relay UE's serving network name as the SNN for AV generation for the remote UE in Prose authentication, and the AMF of the relay network should send this SNN to AUSF/UDM in the Remote UE's home network when triggering Prose Authentication.

However, it is unclear yet how the Remote UE gets the knowledge this SNN and use the same SNN value for authentication vector generation in the UE side.

### SUMMARY

The present disclosure proposes a method and system to determine the Serving Network Name (SNN) value which is used for Proximity Services (ProSe) authentication. In a first embodiment, the remote User Equipment (UE) and home network of the remote UE determine to use a fix value SNN for ProSe authentication, e.g. “5G:Prose”. Thus, regardless of which relay UE is discovered by the remote UE, the ProSe authentication vector can be generated. In another embodiment, the Remote UE can derive the SNN from the cell info of the relay UE from discovery procedure. In yet another embodiment, a Relay UE sends the SNN of the relay network to Remote UE as part of ProSe authentication procedure. This allows security keys to be generated for PC5 communication, based on the common value of SNN in the network side and UE side.

In an embodiment, a method implemented a Fifth Generation (5G) ProSe remote UE for authenticating the 5G ProSe remote UE can include receiving, from a relay UE, a serving network identifier associated with the relay UE and receiving, from the relay UE, a challenge message that was generated by an Authentication Server Function (AUSF) associated with the 5G ProSe remote UE, wherein the challenge message comprises a SNN associated with the relay UE. The method can also include validating the SNN associated with the relay UE with the serving network identifier associated with the relay UE, determining a cipher key, CK′, and an integrity key, IK′, based on the SNN, and providing to the relay UE, a response Challenge message to facilitate authentication of the 5G ProSe remote UE.

In an embodiment, the validating is in response to determining that a control plane based security procedure is used for a Relay Service Code (RSC) for communication with relay UE.

In an embodiment, the determining that the control plane based security procedure is used for the RSC for communication with the relay UE is based on an authentication request associated with the Challenge message.

In an embodiment, prior to receiving the serving network identifier from the relay UE, the method includes providing, to a relay UE, a Direct Communication Request to establish a PC5 unicast link.

In an embodiment, the method includes triggering a discovery procedure with the relay UE to determine cell information associated with the relay UE.

In an embodiment, the cell info further comprises a Tracking Area Identity.

In an embodiment, the SNN comprised in the Challenge message comprises AT_KDF_INPUT of an Extensible Authentication Protocol (EAP) package.

In an embodiment, the Challenge message is an EAP Request/Authentication and Key Agreement, AKA′, Challenge message.

In an embodiment, the response Challenge message is an EAP Response/AKA′-Challenge message.

In an embodiment, the serving network identifier is at least one of Serving Network, SN, identifier, ID, information in a New Radio, NR, Cell Global Identity, NCGI, part of the NCGI, or associated with the NCGI.

In an embodiment, the validating is part of an Extensible Authentication Protocol Authentication and Key Agreement (EAP-AKA′) authentication procedure.

In another embodiment, a 5G ProSe remote UE can include processing circuitry that is configured to cause the 5G ProSe remote UE to receive, from a relay UE, serving network identifier associated with the relay UE and receive, from the relay UE, a challenge message that was generated by an AUSF associated with the 5G ProSe remote UE, wherein the challenge message comprises a SNN associated with the relay UE. The processing circuitry can also be configured to validate the SNN associated with the relay UE with the serving network identifier associated with the relay UE, determine a cipher key, CK′, and an integrity key, IK′, based on the SNN, and provide to the relay UE, a response Challenge message to facilitate authentication of the 5G ProSe remote UE.

In an embodiment, a computer program can be provided that includes instructions which, when executed on at least one processor, cause the processor to carry out the methods above. In an embodiment, a carrier is provided that contains the computer program, wherein the carrier is one of an electronic signal, an optical signal, a radio signal, or a computer readable storage medium.

One of the advantages of the proposed embodiments is that they enable security keys to be generated for PC5 communication based on the common value of the SNN in the network side and UE side, which solves the problem described in the background of how the remote UEs get the knowledge of the SNN and use the same SNN value as the network for authentication vector generation on the UE side.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a reference architecture for Fifth Generation (5G) Proximity Service (ProSe) Layer 3 User Equipment (UE) to Network Relay according to some embodiments of the present disclosure;

FIG. 2 illustrates a high level flow of security for UE-to-Network Relay according to some embodiments of the present disclosure;

FIGS. 3A-3C illustrate a control plane-based message sequence chart for 5G ProSe UE to network relay security procedure with setup of network Prose security context during PC5 link establishment according to some embodiments of the present disclosure;

FIG. 4 illustrates one example of a cellular communications system according to some embodiments of the present disclosure;

FIGS. 5 and 6 illustrate example embodiments in which the cellular communication system of FIG. 4 is a 5G System (5GS);

FIG. 7 is a schematic block diagram of a radio access node according to some embodiments of the present disclosure;

FIG. 8 is a schematic block diagram that illustrates a virtualized embodiment of the radio access node of FIG. 7 according to some embodiments of the present disclosure;

FIG. 9 is a schematic block diagram of the radio access node of FIG. 7 according to some other embodiments of the present disclosure;

FIG. 10 is a schematic block diagram of a UE according to some embodiments of the present disclosure; and

FIG. 11 is a schematic block diagram of the UE of FIG. 10 according to some other embodiments of the present disclosure.

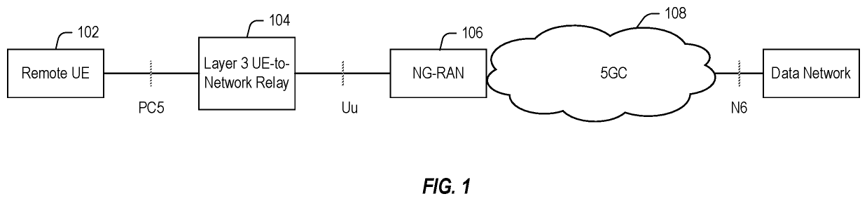

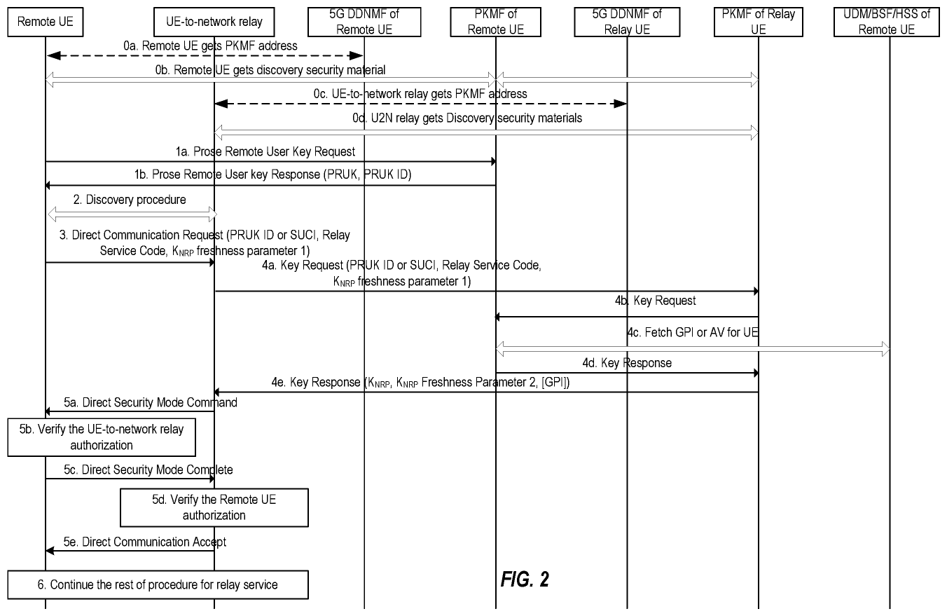

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), ProSe Key Management Function (PKMF) or the like.

User Equipment (UE) Device: One type of UE is a wireless communication device, which may be any type of wireless device that has access to (i.e., is served by) a wireless network (e.g., a cellular network). Some examples of a UE include, but are not limited to: a device in a Third Generation Partnership Project (3GPP) network, a Machine Type Communication (MTC) device, and an Internet of Things (IoT) device. Such UEs may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to Fifth Generation (5G) New Radio (NR) concepts, beams may be used instead of cells and, as such, it is important to note that the concepts described herein are equally applicable to both cells and beams.

The present disclosure proposes a method and system to determine the Serving Network Name (SNN) value which is used for Proximity Services (ProSe) authentication. In a first embodiment, the remote User Equipment (UE) and home network of the remote UE determine to use a fix value SNN for ProSe authentication, e.g., “5G:Prose”. Thus, regardless of which relay UE is discovered by the remote UE, the ProSe authentication vector can be generated. In another embodiment, the Remote UE can derive the SNN from the cell info of the relay UE from discovery procedure. In yet another embodiment, a Relay UE sends the SNN of the relay network to Remote UE as part of ProSe authentication procedure. This allows security keys to be generated for PC5 communication, based on the common value of SNN in the network side and UE side.

One of the advantages of the proposed embodiments is that they enable security keys to be generated for PC5 communication based on the common value of the SNN in the network side and UE side, which solves the problem described in the background of how the remote UEs get the knowledge of the SNN and use the same SNN value as the network for authentication vector generation on the UE side.

The flow described below is based on “6.3.3.3.2 PC5 security establishment for 5G ProSe UE-to-Network relay communication over Control Plane” of TS 33.503. But with new functionality underlined.

### Embodiment 1—Setting SNN with Fixed Value

This clause describes the procedure for establishing a PC5 link between the 5G ProSe Remote UE and the 5G ProSe UE-to-Network Relay. The procedure includes how the 5G ProSe Remote UE is authenticated by the AUSF of the 5G ProSe Remote UE via the 5G ProSe UE-to-Network Relay and the AMF of the 5G ProSe UE-to-Network Relay during 5G ProSe PC5 establishment. This mechanism can be used when the 5G ProSe Remote UE is out of coverage.

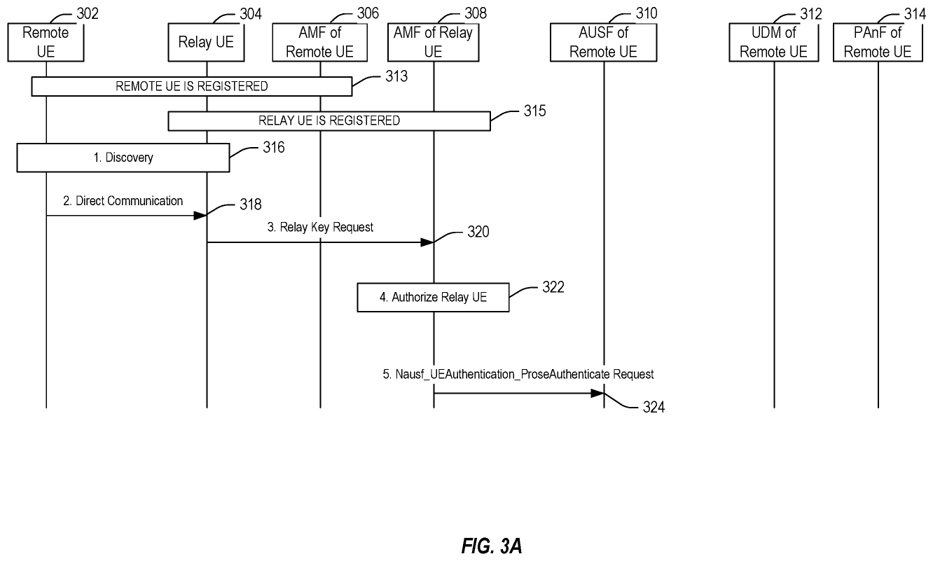

The following steps are described with regard to the message sequence chart in FIGS. 3A-3C that illustrate a control plane-based message sequence chart for 5G ProSe UE to network relay security procedure with setup of network Prose security context during PC5 link establishment according to some embodiments of the present disclosure. The entities in the message sequence chart in FIGS. 3A-3C include a remote UE 302, a Relay UE 304, an Access and Mobility Management Function (AMF) 306 of the remote UE, an AMF 308 of the relay UE, an Authentication Server Function (AUSF) 310 of the remote UE, and Unified Data Manager (UDM) 312 of the remote UE, and Prose Anchor Function (PAnF) 314 of the remote UE. The steps described below correspond to the numbered references in the message sequence charts in FIGS. 3A-3C.

The 5G ProSe Remote UE 302 and the 5G ProSe UE-to-Network Relay shall be registered (steps 313, and 315 respectively) with the network. The 5G ProSe UE-to-Network Relay 304 shall be authenticated and authorized by the network to provide UE-to-Network Relay 304 service. The 5G ProSe Remote UE 302 shall be authenticated and authorized by the AMF 306 to receive UE-to-Network Relay service. PC5 security policies are provisioned to the 5G ProSe Remote UE 302 and the 5G ProSe UE-to-Network Relay 304 respectively during this authorization and information provisioning procedure.

(Step 316) The 5G ProSe Remote UE 302 or Relay UE shall initiate discovery procedure using any of Model A or Model B method as specified in clause 6.3.1.2 or 6.3.1.3 of TS 23.304 V17.3.0, respectively.

(Step 318) After the discovery of the 5G ProSe UE-to-Network Relay 304, the 5G ProSe Remote UE 302 shall send a Direct Communication Request to the 5G ProSe UE-to-Network Relay 304 for establishing secure PC5 unicast link. The 5G ProSe Remote UE 302 shall include its security capabilities and PC5 signalling security policy in the DCR message as specified in TS 33.536. The message shall also include Relay Service Code, Nonce_1.

If the 5G ProSe Remote UE 302 does not have a valid 5G Prose Remote User Key (CP-PRUK), the 5G ProSe Remote UE 302 shall include SUCI in the DCR to trigger 5G ProSe Remote UE specific authentication and establish a CP-PRUK.

If the 5G ProSe Remote UE 302 already has a valid CP-P for Relay Service Code RUK, the 5G ProSe Remote UE 302 shall include associated the CP-PRUK ID in the DCR to indicate that the 5G ProSe Remote UE 302 wants to get relay connectivity using the CP-PRUK.

(Step 320) Upon receiving the DCR message, the 5G ProSe UE-to-Network Relay 304 shall send the Relay Key Request to the AMF 308 of the 5G ProSe UE-to-Network Relay 304, including SUCI or CP-PRUK ID, Relay Service Code (RSC) and Nonce_1 received in the DCR message. The 5G ProSe UE-to-Network Relay 304 shall also include in the message a transaction identifier that identifies the 5G ProSe Remote UE 302 for the subsequent messages over 5G ProSe UE to Network Relay's NAS messages.

(Step 322) The AMF 308 of the 5G ProSe UE-to-Network Relay 304 shall verify with the UDM 312 whether the 5G ProSe UE-to-Network Relay 304 is authorized to provide the UE-to-Network Relay service.

(Step 324) The AMF 308 of the 5G ProSe UE-to-Network Relay 304 shall select an AUSF 310 based on SUCI or CP-PRUK ID and forward the parameters received in Relay Key Request to the AUSF 310 in Nausf_UEAuthentication_ProseAuthenticate Request message. The Nausf_UEAuthentication_ProseAuthenticate Request message shall contain the 5G ProSe Remote UE 302's SUCI or CP-PRUK ID, Relay Service Code, Nonce_1. If CP-PRUK ID is received from AMF 308 of the 5G ProSe UE to Network Relay, the AUSF 310 of the 5G ProSe Remote temporarily stores Nonce_1 and UE skips steps 6-9. If the 5G ProSe Remote UE 302's SUCI is received from AMF 308 of the 5G ProSe UE-to-Network Relay 304, the AUSF 310 of the 5G ProSe Remote UE 302 temporarily stores Nonce_1 and Relay Service Code and skips step 10.

(Step 326) The AUSF 310 shall initiate a 5G ProSe Remote UE specific authentication using the ProSe specific parameters received (i.e., RSC, etc.).

The AUSF 310 knows when Nausf UEAuthentication ProseAuthenticate is used the authentication request is to authenticate the 5G ProSe Remote UE 302, the AUSF 310 determine to use a specific SNN value e.g., “5G:Prose” and include it in the Nudm UEAuthentication GetProseAv Request message.

The AUSF 310 of the 5G ProSe Remote UE 302 shall retrieve the Authentication Vectors and the Routing Indicator of the 5G ProSe Remote UE 302 from the UDM 312 via Nudm_UEAuthentication_GetProseAv Request message. Upon reception of the Nudm_UEAuthentication_GetProSeAv Request, the UDM 312 shall invoke SIDF de-conceal SUCI to gain SUPI before UDM 312 can process the request. The UDM checks whether the UE is authorized to use a ProSe UE-to-Network Relay service based on authorization information in UE's Subscription data. If the UE is authorized, the UDM 312 shall choose the EAP-AKA′ authentication method based on the received Nudm_UEAuthentication_GetProseAv Request.

The UDM/ARPF 312 generates authentication vector and derives CK′/IK′ using the parameters in the Nudm UEAuthentication GetProseAv Request message, e.g. based on the received SNN value.

(Step 328) The AUSF 310 shall temporarily store XRES, Routing indicator and SUPI. The AUSF 310 of the 5G ProSe Remote UE 302 shall trigger authentication of the 5G ProSe Remote UE 302 based on EAP-AKA′. The AUSF 310 of the 5G ProSe Remote UE 302 generates the EAP-Request/AKA′-Challenge message defined in clause 6.1.3.1 of TS 33.501 and send EAP-Request/AKA′-Challenge message to the AMF 308 of the 5G ProSe UE-to-Network Relay 304 in a Nausf_UEAuthentication_ProSeAuthenticate Response message.

(Step 330) The AMF 308 of the 5G ProSe UE-to-Network Relay 304 shall forward the Relay Authentication Request (including the EAP-Request/AKA′-Challenge) to the 5G ProSe UE-to-Network Relay 304 over NAS message, including transaction identifier of the 5G ProSe Remote UE 302 in the message. The NAS message is protected using the NAS security context created for the 5G ProSe UE-to-Network Relay 304.

(Step 332) Based on the transaction identifier, the 5G ProSe UE-to-Network Relay 304 shall forward the EAP-Request/AKA′-Challenge to the 5G ProSe Remote UE 302 over PC5 messages.

The USIM in the 5G ProSe Remote UE 302 verifies the freshness of the received values by checking whether AUTN can be accepted as described in TS 33.102.

For EAP-AKA′, the USIM computes a response RES. The USIM shall return RES, CK, IK to the ME. The ME shall derive CK′ and IK′ according to clause A.3 in TS 33.501.

The UE knows the authentication request is to authenticate the 5G ProSe

Remote UE 302, the UE determines to use a specific SNN value e.g. “5G:Prose” as input to derive CK′ and IK′.

(Step 334) The 5G ProSe Remote UE 302 shall return EAP-Response/AKA′-Challenge to the 5G ProSe UE-to-Network Relay 304 over PC5 messages.

(Step 336) The 5G ProSe UE-to-Network Relay 304 forwards the EAP-Response/AKA′-Challenge together with the transaction identifier of the 5G ProSe Remote UE 302 to the AMF 308 of the 5G ProSe UE-to-Network Relay 304 in a NAS message Relay Authentication Response.

(Step 338) The AMF 304 of the 5G ProSe UE-to-Network Relay forwards EAP-Response/AKA′-Challenge to the AUSF 310 of the 5G ProSe Remote UE 302 via Nausf_UEAuthentication_ProSeAuthenticate Request.

The AUSF 310 of the 5G ProSe Remote UE 302 performs the UE authentication by verifying the received information as described in TS 33.501.

For EAP-AKA′, the AUSF 310 of the 5G ProSe Remote UE 302 and the 5G ProSe Remote UE 302 may exchange EAP-Request/AKA′-Notification and EAP-Response/AKA′-Notification messages via the AMF 308 of the 5G ProSe UE-to-Network Relay 304 and the 5G ProSe UE-to-Network Relay 304. After the exchanges, the AUSF 310 of the 5G ProSe Remote UE 302 and the 5G ProSe Remote UE 302 shall derive the KAUSF_P in the same way as KAUSF is derived in TS 33.501.

(Steps 340 and 342) On successful authentication, the AUSF 310 of the 5G ProSe Remote UE 302 (step 340) and the 5G ProSe Remote UE 302 (step 342) shall generate CP-PRUK as specified in clause A.2 and CP-PRUK ID.

The CP-PRUK ID is in NAI format as specified in clause 2.2 of IETF RFC 7542, i.e., username@realm. The username part includes the Routing Indicator from step 6 and the CP-PRUK ID*, and the realm part includes Home Network Identifier. The CP-PRUK ID* is specified in clause A.3.

(Step 344) The AUSF 310 of the 5G ProSe Remote UE 302 shall select the PAnF 314 (Prose Anchor Function) based on CP-PRUK ID and send the SUPI, RSC, CP-PRUK and CP-PRUK ID in Npanf_ProseKey_Register Request message to the PAnF.

(Step 346) The PAnF 314 shall store the Prose context info (i.e., SUPI, RSC, CP-PRUK, CP-PRUK ID) for the 5G ProSe Remote UE 302 and send Npanf_ProseKey_Register Response message to the AUSF 310.

(Step 348) The AUSF 310 of the 5G ProSe Remote UE 302 shall select the PAnF 314 based on CP-PRUK ID and send received CP-PRUK ID and RSC in Npanf_ProseKey_get Request message.

(Step 350) The PAnF 314 retrieves CP-PRUK based on the CP-PRUK ID and checks whether the 5G ProSe Remote UE 302 is authorized to use the UE-to-Network Relay service based on received RSC. If the 5G ProSe Remote UE 302 is authorized and the retrieved CP-PRUK is valid, the PAnF 314 sends Npanf_ProseKey_get Response message with CP-PRUK to the AUSF 310.

(Step 352) The AUSF 310 of the 5G ProSe Remote UE 302 shall generate Nonce_2 and derive the KNR_ProSe key using CP-PRUK, Nonce_1 and Nonce_2 as defined in clause A.4.

(Step 354) The AUSF 310 of the 5G ProSe Remote UE 302 shall send the KNR_ProSe, Nonce_2 in Nausf_UEAuthentication_ProseAuthenticate Response message to the 5G ProSe UE-to-Network Relay 304 via the AMF 308 of the 5G ProSe UE-to-Network Relay 304. EAP Success message shall be included if step 7 is performed successfully. The AUSF 310 of the 5G ProSe Remote UE 302 shall also include the CP-PRUK ID in the message.

(Step 356) When receiving a KNR_ProSe from the AUSF 310 of the 5G ProSe Remote UE 302 via the AMF 308 of the 5G ProSe UE-to-Network Relay 304, the 5G ProSe UE-to-Network Relay 304 derives PC5 session key Krelay-sess and confidentiality key Krelay-enc (if applicable) and integrity key Krelay-int from KNR_ProSe. KNR_ProSe ID and Krelay-sess ID are established in the same way as KNRP ID and KNRP-sess ID in TS 33.536. The 5GPRUK ID is sent from the AMF 308 of the 5G ProSe UE to-Network Relay to UE-to-Network Relay 304. The EAP Success message is also sent from the AMF 308 of the 5G ProSe UE to-Network Relay to UE-to-Network Relay if received from AUSF 310.

(Step 358) The 5G ProSe UE-to-Network Relay 304 shall send the received Nonce_2 and 5G ProSe Remote UE 302's PC5 signalling security policy to the 5G ProSe Remote UE 302 in Direct Security mode command message, which is integrity protected using Krelay-int. EAP Success message shall be included if received from the AMF 308 of the 5G ProSe UE-to-Network Relay 304.

(Step 360) The 5G ProSe Remote UE 302 shall generate the KNR_ProSe key to be used for remote access via the 5G ProSe UE to-Network Relay in the same way as defined in step 11. The 5G ProSe Remote UE 302 shall derive PC5 session key Krelay-sess and confidentiality and integrity keys from KNR_ProSe in the same way as defined in step 13.

The 5G ProSe Remote UE 302 shall verify the Direct Security Mode Command message. Successful verification of the Direct Security Mode Command message assures the 5G ProSe Remote UE 302 that the 5G ProSe UE-to-Network Relay 304 is authorized to provide the relay service.

(Step 362) The 5G ProSe Remote UE 302 shall send the Direct Security Mode Complete message containing its PC5 user plane security policies to the 5G ProSe UE-to-Network Relay 304, which is protected by Krelay-int or/and Krelay-enc derived from Krelay-sess according to the negotiated PC5 signalling policies between the 5G ProSe Remote UE 302 and the 5G ProSe UE-to-Network Relay 304.

(Step 364) On receiving the Direct Security Mode Complete message, the 5G ProSe UE-to-Network Relay 304 shall verify the Direct Security Mode Complete message. Successful verification of the Direct Security Mode Complete message assures the 5G ProSe UE-to-Network Relay 304 that the 5G ProSe Remote UE 302 is authorized to get the relay service.

After the successful verification of the Direct Security Mode complete message, the 5G ProSe UE-to-Network Relay 304 responds a Direct Communication Accept message to the 5G ProSe Remote UE 302 to finish the PC5 connection establishment procedures and store the CP-PRUK ID in the security context associated to the PC5 link with the 5G ProSe Remote UE 302.

Further communication between the 5G ProSe Remote UE 302 and the Network takes place securely via the 5G ProSe UE to-Network Relay.

When the 5G ProSe Layer-3 UE-to-Network Relay 304 sends a Remote UE Report to the SMF as specified in TS 23.304, the 5G ProSe Layer-3 UE-to-Network Relay 304 shall include Remote User ID (i.e., the 5GPRUK ID received in step 13) in the message.

### Embodiment 2—Remote Determine SNN from Cell Info of Relay UE

The flow is similar to Embodiment 1, with the following differences underlined.

### Precondition (Part of Step 316),

In case the Remote UE 302 learns CP based security procedure is used for the RSC for PC5 communication with Relay UE 304, it triggers discovery procedure, e.g., via Relay Discovery Additional Information message to learn the cell info where the Relay UE 304 camps. The Remote UE 302 derives the SNN based on the cell info where the Relay UE 304 camps, e.g. NR Cell Global Identity (NCGI) or Tracking Area Identity (TAI).

(Step 313 and 315) The 5G ProSe Remote UE 302 and the 5G ProSe UE-to-Network Relay 304 shall be registered with the network. The 5G ProSe UE-to-Network Relay 304 shall be authenticated and authorized by the network to provide UE-to-Network Relay 304 service. The 5G ProSe Remote UE 302 shall be authenticated and authorized by the network to receive UE-to-Network Relay service. PC5 security policies are provisioned to the 5G ProSe Remote UE 302 and the 5G ProSe UE-to-Network Relay 304 respectively during this authorization and information provisioning procedure.

(Step 316) The 5G ProSe Remote UE 302 or Relay UE 304 shall initiate discovery procedure using any of Model A or Model B method as specified in clause 6.3.1.2 or 6.3.1.3 of TS 23.304, respectively.

(Step 318) After the discovery of the 5G ProSe UE-to-Network Relay 304, the 5G ProSe Remote UE 302 shall send a Direct Communication Request to the 5G ProSe UE-to-Network Relay 304 for establishing secure PC5 unicast link. The 5G ProSe Remote UE 302 shall include its security capabilities and PC5 signalling security policy in the DCR message as specified in TS 33.536. The message shall also include Relay Service Code, Nonce_1.

If the 5G ProSe Remote UE 302 does not have a valid 5G Prose Remote User Key (CP-PRUK), the 5G ProSe Remote UE 302 shall include SUCI in the DCR to trigger 5G ProSe Remote UE 302 specific authentication and establish a CP-PRUK.

If the 5G ProSe Remote UE 302 already has a valid CP-P for Relay Service Code RUK, the 5G ProSe Remote UE 302 shall include associated the CP-PRUK ID in the DCR to indicate that the 5G ProSe Remote UE 302 wants to get relay connectivity using the CP-PRUK.

(Step 320) Upon receiving the DCR message, the 5G ProSe UE-to-Network Relay 304 shall send the Relay Key Request to the AMF 308 of the 5G ProSe UE-to-Network Relay 304, including SUCI or CP-PRUK ID, RSC and Nonce_1 received in the DCR message. The 5G ProSe UE-to-Network Relay 304 shall also include in the message a transaction identifier that identifies the 5G ProSe Remote UE 302 for the subsequent messages over 5G ProSe UE to Network Relay's NAS messages.

(Step 322) The AMF 308 of the 5G ProSe UE-to-Network Relay 304 shall verify with the UDM 312 whether the 5G ProSe UE-to-Network Relay 304 is authorized to provide the UE-to-Network Relay service.

(Step 324) The AMF 308 of the 5G ProSe UE-to-Network Relay 304 shall select an AUSF 310 based on SUCI or CP-PRUK ID and forward the parameters received in Relay Key Request to the AUSF 310 in Nausf_UEAuthentication_ProseAuthenticate Request message. The Nausf_UEAuthentication_ProseAuthenticate Request message shall contain the 5G ProSe Remote UE 302's SUCI or CP-PRUK ID, Relay Service Code, Nonce_1, and SNN of relay UE. If CP-PRUK ID is received from AMF 308 of the 5G ProSe UE to Network Relay, the AUSF 310 of the 5G ProSe Remote temporarily stores Nonce_1 and UE skips steps 6-9. If the 5G ProSe Remote UE 302's SUCI is received from AMF 308 of the 5G ProSe UE-to-Network Relay 304, the AUSF 310 of the 5G ProSe Remote UE 302 temporarily stores Nonce_1 and Relay Service Code and skips step 10.

(Step 326) The AUSF 310 shall initiate a 5G ProSe Remote UE 302 specific authentication using the ProSe specific parameters received (i.e., RSC, etc.).

The AUSF 310 of the 5G ProSe Remote UE 302 shall retrieve the Authentication Vectors and the Routing Indicator of the 5G ProSe Remote UE 302 from the UDM 312 via Nudm_UEAuthentication_GetProseAv Request message. Upon reception of the Nudm_UEAuthentication_GetProSeAv Request, the UDM shall invoke SIDF de-conceal SUCI to gain SUPI before UDM can process the request. The UDM checks whether the UE is authorized to use a ProSe UE-to-Network Relay service based on authorization information in UE's Subscription data. If the UE is authorized, the UDM shall choose the EAP-AKA′ authentication method based on the received Nudm_UEAuthentication_GetProseAv Request.

The UDM/ARPF 312 generates authentication vector and derives CK′/IK′ using the parameters in the Nudm_UEAuthentication_GetProseAv Request message, e.g., based on the received SNN value.

(Step 328) The AUSF 310 shall temporarily store XRES, Routing indicator and SUPI. The AUSF 310 of the 5G ProSe Remote UE 302 shall trigger authentication of the 5G ProSe Remote UE 302 based on EAP-AKA′. The AUSF 310 of the 5G ProSe Remote UE 302 generates the EAP-Request/AKA′-Challenge message defined in clause 6.1.3.1 of TS 33.501 and send EAP-Request/AKA′-Challenge message to the AMF 308 of the 5G ProSe UE-to-Network Relay 304 in a Nausf_UEAuthentication_ProSeAuthenticate Response message.

(Step 330) The AMF 308 of the 5G ProSe UE-to-Network Relay 304 shall forward the Relay Authentication Request (including the EAP-Request/AKA′-Challenge) to the 5G ProSe UE-to-Network Relay 304 over NAS message, including transaction identifier of the 5G ProSe Remote UE 302 in the message. The NAS message is protected using the NAS security context created for the 5G ProSe UE-to-Network Relay 304.

(Step 332) Based on the transaction identifier, the 5G ProSe UE-to-Network Relay 304 shall forwards the EAP-Request/AKA′-Challenge to the 5G ProSe Remote UE 302 over PC5 messages.

The USIM in the 5G ProSe Remote UE 302 verifies the freshness of the received values by checking whether AUTN can be accepted as described in TS 33.102.

For EAP-AKA′, the USIM computes a response RES. The USIM shall return RES, CK, IK to the ME. The ME shall derive CK′ and IK′ according to clause A.3 in TS 33.501.

The UE knows the authentication request is to authenticate the 5G ProSe Remote UE 302, the UE determine to use a SNN value.
either the one retrieved from “Precondition” step
or SNN value received from the network side via AT KDF INPUT of EAP package and validate the received SNN value matched with the one retrieved from “Precondition” step.

The UE uses the SNN value to as input to derive CK′ and IK′.

The rest of the procedure is the same as Embodiment 1.

### Embodiment 3—Relay UE Sends SNN to Remote for Security Keys Generation

The flow is same as Embodiment 1, with the following differences underlined.

(Steps 313 and 315) The 5G ProSe Remote UE 302 and the 5G ProSe UE-to-Network Relay 304 shall be registered with the network. The 5G ProSe UE-to-Network Relay 304 shall be authenticated and authorized by the network to provide UE-to-Network Relay service. The 5G ProSe Remote UE 302 shall be authenticated and authorized by the network to receive UE-to-Network Relay service. PC5 security policies are provisioned to the 5G ProSe Remote UE 302 and the 5G ProSe UE-to-Network Relay 304 respectively during this authorization and information provisioning procedure.

(Step 316) The 5G ProSe Remote UE 302 or Relay UE shall initiate discovery procedure using any of Model A or Model B method as specified in clause 6.3.1.2 or 6.3.1.3 of TS 23.304, respectively.

(Step 318) After the discovery of the 5G ProSe UE-to-Network Relay 304, the 5G ProSe Remote UE 302 shall send a Direct Communication Request to the 5G ProSe UE-to-Network Relay 304 for establishing secure PC5 unicast link. The 5G ProSe Remote UE 302 shall include its security capabilities and PC5 signalling security policy in the DCR message as specified in TS 33.536. The message shall also include Relay Service Code, Nonce_1.

If the 5G ProSe Remote UE 302 does not have a valid 5G Prose Remote User Key (CP-PRUK), the 5G ProSe Remote UE 302 shall include SUCI in the DCR to trigger 5G ProSe Remote UE 302 specific authentication and establish a CP-PRUK.

If the 5G ProSe Remote UE 302 already has a valid CP-P for Relay Service Code RUK, the 5G ProSe Remote UE 302 shall include associated the CP-PRUK ID in the DCR to indicate that the 5G ProSe Remote UE 302 wants to get relay connectivity using the CP-PRUK.

(Step 320) Upon receiving the DCR message, the 5G ProSe UE-to-Network Relay 304 shall send the Relay Key Request to the AMF 308 of the 5G ProSe UE-to-Network Relay 304, including SUCI or CP-PRUK ID, RSC and Nonce_1 received in the DCR message. The 5G ProSe UE-to-Network Relay 304 shall also include in the message a transaction identifier that identifies the 5G ProSe Remote UE 302 for the subsequent messages over 5G ProSe UE to Network Relay's NAS messages.

(Step 322) The AMF 308 of the 5G ProSe UE-to-Network Relay 304 shall verify with the UDM 312 whether the 5G ProSe UE-to-Network Relay 304 is authorized to provide the UE-to-Network Relay service.

(Step 324) The AMF 308 of the 5G ProSe UE-to-Network Relay 304 shall select an AUSF 310 based on SUCI or CP-PRUK ID and forward the parameters received in Relay Key Request to the AUSF 310 in Nausf_UEAuthentication_ProseAuthenticate Request message. The Nausf_UEAuthentication_ProseAuthenticate Request message shall contain the 5G ProSe Remote UE 302's SUCI or CP-PRUK ID, Relay Service Code, Nonce_1, and SNN of relay UE. If CP-PRUK ID is received from AMF 308 of the 5G ProSe UE to Network Relay, the AUSF 310 of the 5G ProSe Remote temporarily stores Nonce_1 and UE skips steps 6-9. If the 5G ProSe Remote UE 302's SUCI is received from AMF 308 of the 5G ProSe UE-to-Network Relay 304, the AUSF 310 of the 5G ProSe Remote UE 302 temporarily stores Nonce_1 and Relay Service Code and skips step 10.

(Step 326) The AUSF 310 shall initiate a 5G ProSe Remote UE 302 specific authentication using the ProSe specific parameters received (i.e., RSC, etc.).

The AUSF 310 of the 5G ProSe Remote UE 302 shall retrieve the Authentication Vectors and the Routing Indicator of the 5G ProSe Remote UE 302 from the UDM 312 via Nudm_UEAuthentication_GetProseAv Request message. Upon reception of the Nudm_UEAuthentication_GetProSeAv Request, the UDM 312 shall invoke SIDF de-conceal SUCI to gain SUPI before UDM 312 can process the request. The UDM 312 checks whether the UE is authorized to use a ProSe UE-to-Network Relay service based on authorization information in UE's Subscription data. If the UE is authorized, the UDM 312 shall choose the EAP-AKA′ authentication method based on the received Nudm_UEAuthentication_GetProseAv Request.

The UDM/ARPF generates authentication vector and derives CK′/IK′ using the parameters in the Nudm_UEAuthentication_GetProseAv Request message, e.g., based on the received SNN value.

(Step 328) The AUSF 310 shall temporarily store XRES, Routing indicator and SUPI. The AUSF 310 of the 5G ProSe Remote UE 302 shall trigger authentication of the 5G ProSe Remote UE 302 based on EAP-AKA′. The AUSF 310 of the 5G ProSe Remote UE 302 generates the EAP-Request/AKA′-Challenge message defined in clause 6.1.3.1 of TS 33.501 and send EAP-Request/AKA′-Challenge message to the AMF 308 of the 5G ProSe UE-to-Network Relay 304 in a Nausf_UEAuthentication_ProSeAuthenticate Response message.

(Step 330) The AMF 308 of the 5G ProSe UE-to-Network Relay 304 shall forward the Relay Authentication Request (including the EAP-Request/AKA′-Challenge) to the 5G ProSe UE-to-Network Relay 304 over NAS message, including transaction identifier of the 5G ProSe Remote UE 302 in the message. The NAS message is protected using the NAS security context created for the 5G ProSe UE-to-Network Relay 304.

(Step 332) Based on the transaction identifier, the 5G ProSe UE-to-Network Relay 304 shall forwards the EAP-Request/AKA′-Challenge to the 5G ProSe Remote UE 302 over PC5 messages. In the message, the 5G ProSe UE-to-Network Relay 304 UE also includes the SNN of the relay UE.

The USIM in the 5G ProSe Remote UE 302 verifies the freshness of the received values by checking whether AUTN can be accepted as described in TS 33.102.

For EAP-AKA′, the USIM computes a response RES. The USIM shall return RES, CK, IK to the ME. The ME shall derive CK′ and IK′ according to clause A.3 in TS 33.501.

The UE knows the authentication request is to authenticate the 5G ProSe Remote UE 302, the UE determine to use a SNN value:
either the one retrieved from the relay UE
or SNN value received from the network side via AT KDF INPUT of EAP package and validate the received SNN value matched with the one retrieved from “relay UE.

The UE uses the SNN value to as input to derive CK′ and IK′.

The rest of the procedure is the same as Embodiment 1.

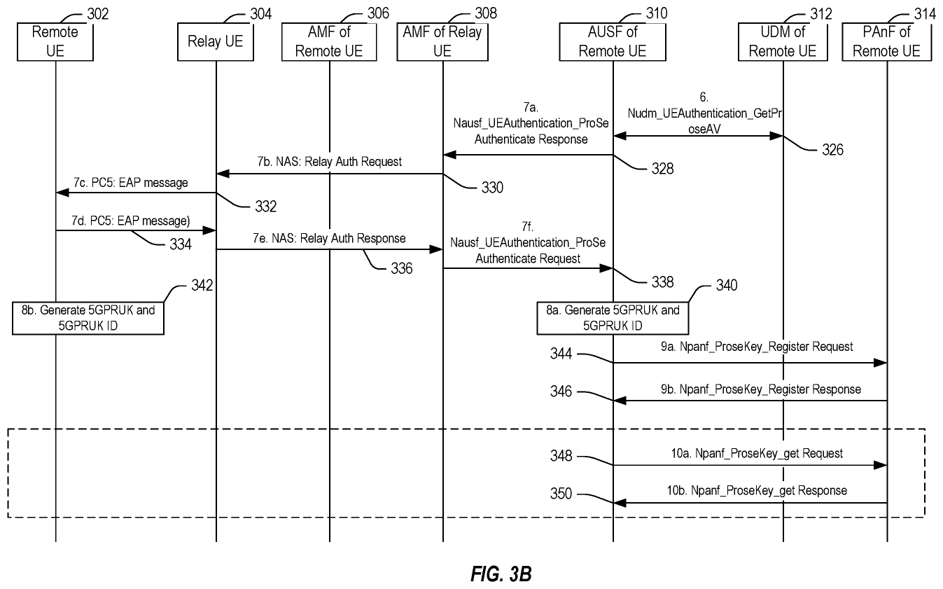

FIG. 4 illustrates one example of a cellular communications system 400 in which embodiments of the present disclosure may be implemented. In the embodiments described herein, the cellular communications system 400 is a 5G system (5GS) including a Next Generation RAN (NG-RAN) and a 5G Core (5GC). In this example, the RAN includes base stations 402-1 and 402-2, which in the 5GS include NR base stations (gNBs) and optionally next generation eNBs (ng-eNBs, controlling corresponding (macro) cells 404-1 and 404-2. The base stations 402-1 and 402-2 are generally referred to herein collectively as base stations 402 and individually as base station 402. Likewise, the (macro) cells 404-1 and 404-2 are generally referred to herein collectively as (macro) cells 404 and individually as (macro) cell 404. The RAN may also include a number of low power nodes 406-1 through 406-4 controlling corresponding small cells 408-1 through 408-4. The low power nodes 406-1 through 406-4 can be small base stations (such as pico or femto base stations) or RRHs, or the like. Notably, while not illustrated, one or more of the small cells 408-1 through 408-4 may alternatively be provided by the base stations 402. The low power nodes 406-1 through 406-4 are generally referred to herein collectively as low power nodes 406 and individually as low power node 406. Likewise, the small cells 408-1 through 408-4 are generally referred to herein collectively as small cells 408 and individually as small cell 408. The cellular communications system 400 also includes a core network 410, which in the 5G System (5GS) is referred to as the 5GC. The base stations 402 (and optionally the low power nodes 406) are connected to the core network 410.

The base stations 402 and the low power nodes 406 provide service to wireless communication devices 412-1 through 412-5 in the corresponding cells 404 and 408. The wireless communication devices 412-1 through 412-5 are generally referred to herein collectively as wireless communication devices 412 and individually as wireless communication device 412. In the following description, the wireless communication devices 412 are oftentimes UEs, but the present disclosure is not limited thereto. The remote UE 302 and relay UE 304 can be examples of the wireless communications devices 412, and the base stations 402 can provide communications to the remote UE 302 and relay UE 304 to and from the network functions such as the AMF 306 and AMF 308, AUSF 310, and UDM 312 and PAnF 314.

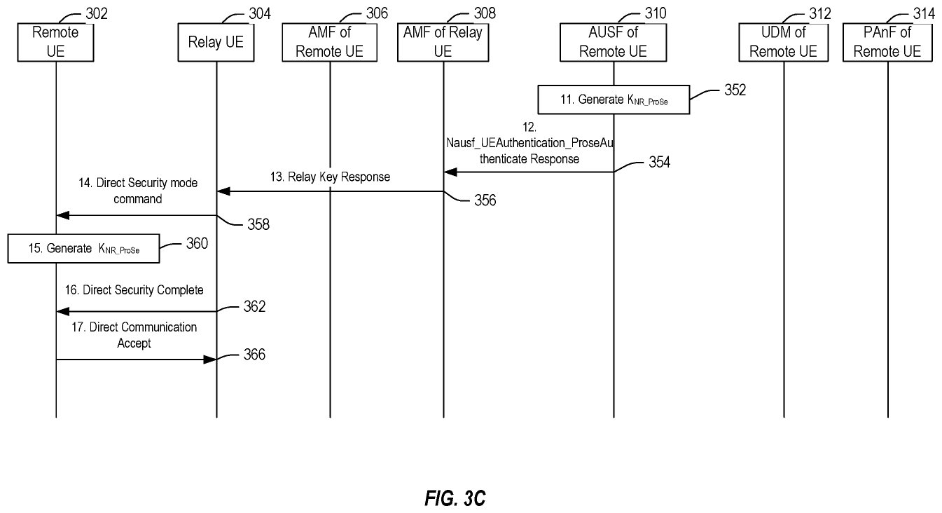

FIG. 5 illustrates a wireless communication system represented as a 5G network architecture composed of core Network Functions (NFs), where interaction between any two NFs is represented by a point-to-point reference point/interface. FIG. 5 can be viewed as one particular implementation of the system 400 of FIG. 4.

Seen from the access side the 5G network architecture shown in FIG. 5 comprises a plurality of UEs 412 connected to either a RAN 402 or an Access Network (AN) as well as an AMF 500. Typically, the R (AN) 402 comprises base stations, e.g., such as eNBs or gNBs or similar. Seen from the core network side, the 5GC NFs shown in FIG. 5 include a NSSF 502, an AUSF 504, a UDM 506, the AMF 500, a SMF 508, a PCF 510, and an Application Function (AF) 512. The AUSF 504 described here can be an example of the AUSF 310 described in the procedure above. Likewise, the UDM 506 described here can be an example of the UDM 312 described in the procedure above.

Reference point representations of the 5G network architecture are used to develop detailed call flows in the normative standardization. The N1 reference point is defined to carry signaling between the UE 412 and AMF 500. The reference points for connecting between the AN 402 and AMF 500 and between the AN 402 and UPF 514 are defined as N2 and N3, respectively. There is a reference point, N11, between the AMF 500 and SMF 508, which implies that the SMF 508 is at least partly controlled by the AMF 500. N4 is used by the SMF 508 and UPF 514 so that the UPF 514 can be set using the control signal generated by the SMF 508, and the UPF 514 can report its state to the SMF 508. N9 is the reference point for the connection between different UPFs 514, and N14 is the reference point connecting between different AMFs 500, respectively. N15 and N7 are defined since the PCF 510 applies policy to the AMF 500 and SMF 508, respectively. N12 is required for the AMF 500 to perform authentication of the UE 412. N8 and N10 are defined because the subscription data of the UE 412 is required for the AMF 500 and SMF 508. In an embodiment, the AMF 500 described herein can be an example of the AMF 306 and AMF 308 described in the procedure above.

The 5GC network aims at separating UP and CP. The UP carries user traffic while the CP carries signaling in the network. In FIG. 5, the UPF 514 is in the UP and all other NFs, i.e., the AMF 500, SMF 508, PCF 510, AF 512, NSSF 502, AUSF 504, and UDM 506, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 500 and SMF 508 are independent functions in the CP. Separated AMF 500 and SMF 508 allow independent evolution and scaling. Other CP functions like the PCF 510 and AUSF 504 can be separated as shown in FIG. 5. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

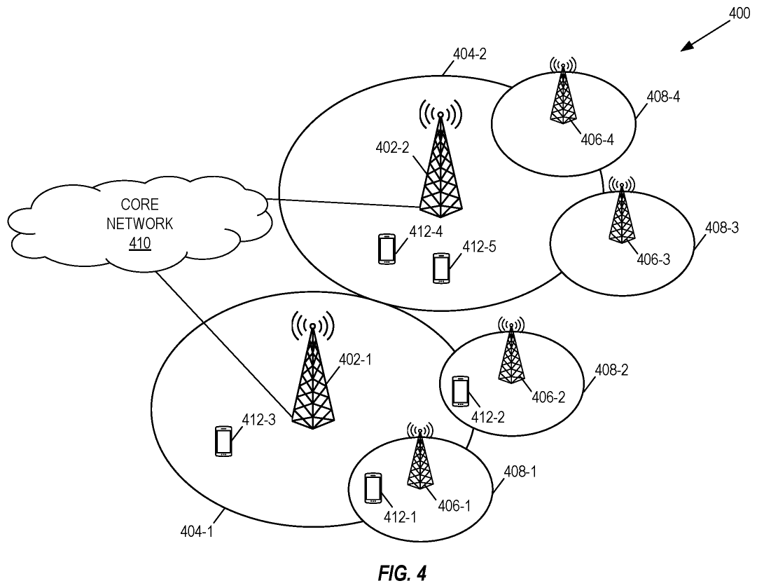

FIG. 6 illustrates a 5G network architecture using service-based interfaces between the NFs in the CP, instead of the point-to-point reference points/interfaces used in the 5G network architecture of FIG. 5. However, the NFs described above with reference to FIG. 5 correspond to the NFs shown in FIG. 6. The service(s) etc. that a NF provides to other authorized NFs can be exposed to the authorized NFs through the service-based interface. In FIG. 6 the service based interfaces are indicated by the letter “N” followed by the name of the NF, e.g., Namf for the service based interface of the AMF 500 and Nsmf for the service based interface of the SMF 508, etc. The NEF 600 and the NRF 602 in FIG. 6 are not shown in FIG. 5 discussed above. However, it should be clarified that all NFs depicted in FIG. 5 can interact with the NEF 600 and the NRF 602 of FIG. 6 as necessary, though not explicitly indicated in FIG. 5.

Some properties of the NFs shown in FIGS. 5 and 6 may be described in the following manner. The AMF 500 provides UE-based authentication, authorization, mobility management, etc. A UE 412 even using multiple access technologies is basically connected to a single AMF 500 because the AMF 500 is independent of the access technologies. The SMF 508 is responsible for session management and allocates Internet Protocol (IP) addresses to UEs. It also selects and controls the UPF 514 for data transfer. If a UE 412 has multiple sessions, different SMFs 508 may be allocated to each session to manage them individually and possibly provide different functionalities per session. The AF 512 provides information on the packet flow to the PCF 510 responsible for policy control in order to support QoS. Based on the information, the PCF 510 determines policies about mobility and session management to make the AMF 500 and SMF 508 operate properly. The AUSF 504 supports authentication function for UEs or similar and thus stores data for authentication of UEs or similar while the UDM 506 stores subscription data of the UE 412. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

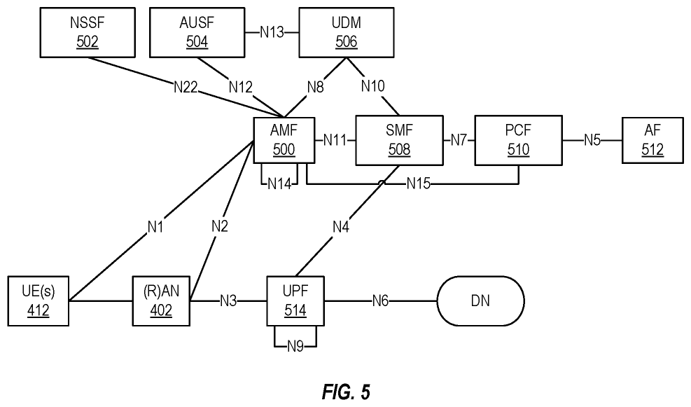

FIG. 7 is a schematic block diagram of a radio access node 700 according to some embodiments of the present disclosure. Optional features are represented by dashed boxes. The radio access node 700 may be, for example, a base station 402 or 406 or a network node that implements all or part of the functionality of the base station 402 or gNB described herein. As illustrated, the radio access node 700 includes a control system 702 that includes one or more processors 704 (e.g., Central Processing Units (CPUs), Application Specific Integrated Circuits (ASICs), Field Programmable Gate Arrays (FPGAS), and/or the like), memory 706, and a network interface 708. The one or more processors 704 are also referred to herein as processing circuitry. In addition, the radio access node 700 may include one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of a radio access node 700 as described herein. In some embodiments, the function(s) are implemented in software that is stored, e.g., in the memory 706 and executed by the one or more processors 704.

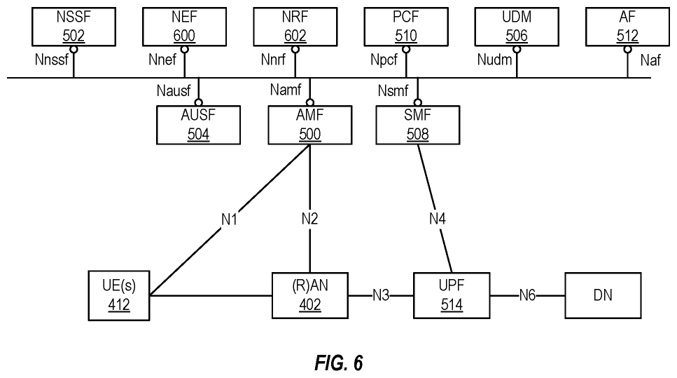

FIG. 8 is a schematic block diagram that illustrates a virtualized embodiment of the radio access node 700 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 700 in which at least a portion of the functionality of the radio access node 700 is implemented as a virtual component(s) (e.g., via a virtual machine(s) executing on a physical processing node(s) in a network(s)). As illustrated, in this example, the radio access node 700 may include the control system 702 and/or the one or more radio units 710, as described above. The control system 702 may be connected to the radio unit(s) 710 via, for example, an optical cable or the like. The radio access node 700 includes one or more processing nodes 800 coupled to or included as part of a network(s) 802. If present, the control system 702 or the radio unit(s) are connected to the processing node(s) 800 via the network 802. Each processing node 800 includes one or more processors 804 (e.g., CPUs, ASICS, FPGAS, and/or the like), memory 806, and a network interface 808.

In this example, functions 810 of the radio access node 700 described herein are implemented at the one or more processing nodes 800 or distributed across the one or more processing nodes 800 and the control system 702 and/or the radio unit(s) 710 in any desired manner. In some particular embodiments, some or all of the functions 810 of the radio access node 700 described herein are implemented as virtual components executed by one or more virtual machines implemented in a virtual environment(s) hosted by the processing node(s) 800. As will be appreciated by one of ordinary skill in the art, additional signaling or communication between the processing node(s) 800 and the control system 702 is used in order to carry out at least some of the desired functions 810. Notably, in some embodiments, the control system 702 may not be included, in which case the radio unit(s) 710 communicate directly with the processing node(s) 800 via an appropriate network interface(s).

In some embodiments, a computer program including instructions which, when executed by at least one processor, causes the at least one processor to carry out the functionality of radio access node 700 or a node (e.g., a processing node 800) implementing one or more of the functions 810 of the radio access node 700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

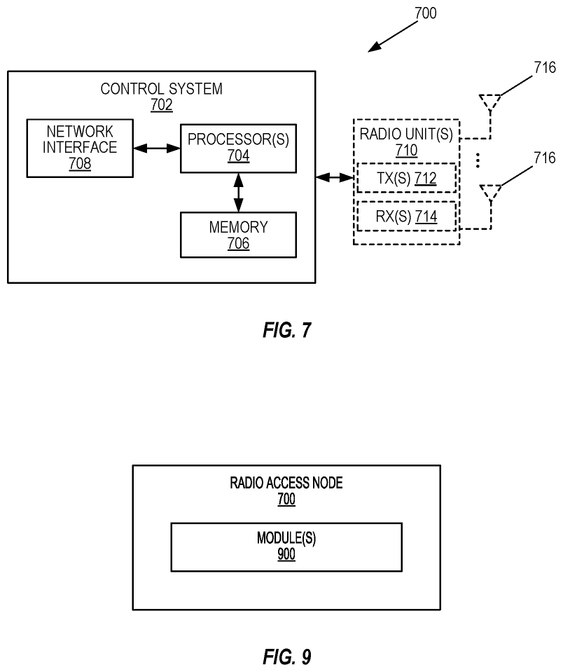

FIG. 9 is a schematic block diagram of the radio access node 700 according to some other embodiments of the present disclosure. The radio access node 700 includes one or more modules 900, each of which is implemented in software. The module(s) 900 provide the functionality of the radio access node 700 described herein. This discussion is equally applicable to the processing node 800 of FIG. 8 where the modules 900 may be implemented at one of the processing nodes 800 or distributed across multiple processing nodes 800 and/or distributed across the processing node(s) 800 and the control system 702.

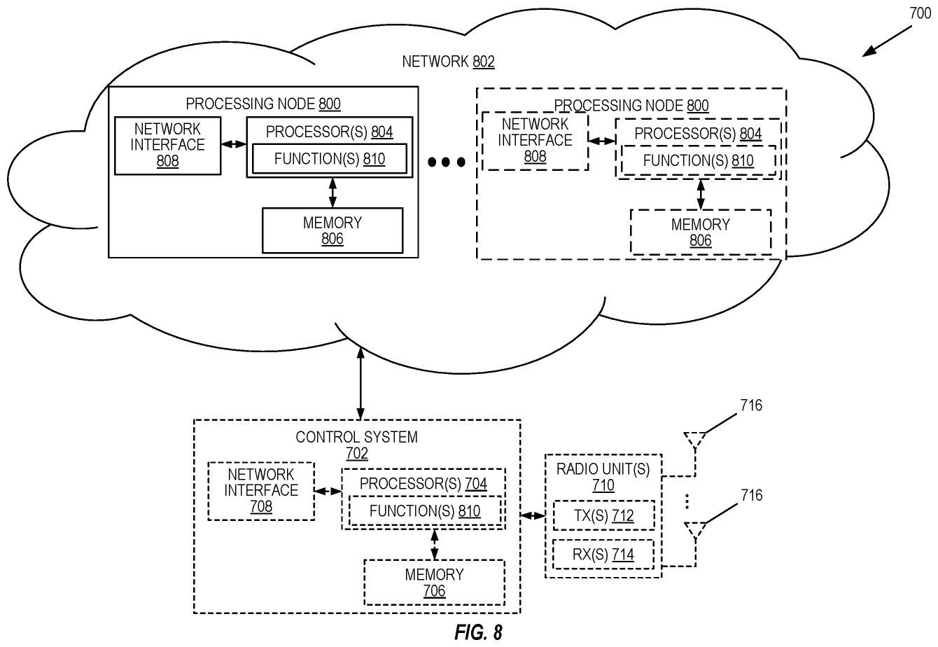

FIG. 10 is a schematic block diagram of a wireless communication device 1000 according to some embodiments of the present disclosure. As illustrated, the wireless communication device 1000 includes one or more processors 1002 (e.g., CPUS, ASICS, FPGAs, and/or the like), memory 1004, and one or more transceivers 1006 each including one or more transmitters 1008 and one or more receivers 1010 coupled to one or more antennas 1012. The transceiver(s) 1006 includes radio-front end circuitry connected to the antenna(s) 1012 that is configured to condition signals communicated between the antenna(s) 1012 and the processor(s) 1002, as will be appreciated by on of ordinary skill in the art. The processors 1002 are also referred to herein as processing circuitry. The transceivers 1006 are also referred to herein as radio circuitry. In some embodiments, the functionality of the wireless communication device 1000 described above may be fully or partially implemented in software that is, e.g., stored in the memory 1004 and executed by the processor(s) 1002. Note that the wireless communication device 1000 may include additional components not illustrated in FIG. 10 such as, e.g., one or more user interface components (e.g., an input/output interface including a display, buttons, a touch screen, a microphone, a speaker(s), and/or the like and/or any other components for allowing input of information into the wireless communication device 1000 and/or allowing output of information from the wireless communication device 1000), a power supply (e.g., a battery and associated power circuitry), etc.

In some embodiments, a computer program including instructions which, when executed by at least one processor, causes the at least one processor to carry out the functionality of the wireless communication device 1000 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

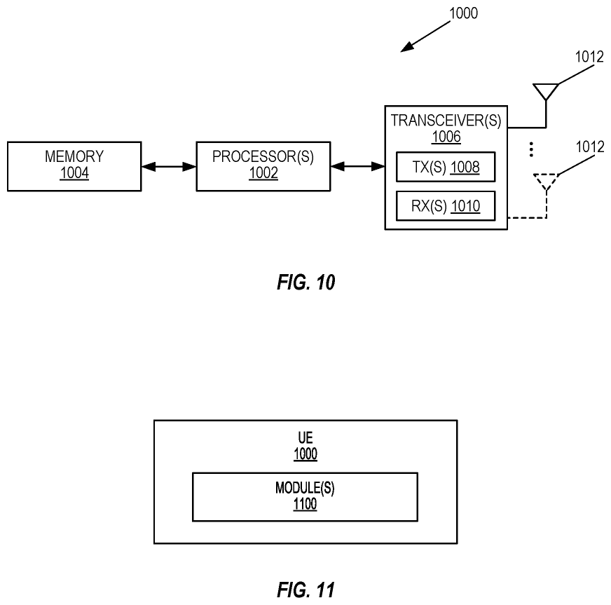

FIG. 11 is a schematic block diagram of the wireless communication device 1000 according to some other embodiments of the present disclosure. The wireless communication device 1000 includes one or more modules 1100, each of which is implemented in software. The module(s) 1100 provide the functionality of the wireless communication device 1000 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

Some of the embodiments of the present disclosure can include:
Embodiment 1. A method implemented in an Authentication Server Function, AUSF, (310) of a remote network for authenticating a 5G Proximity Service, ProSe, remote User Equipment, UE, (302) comprising: receiving (step 324, FIG. 3A), from an Access and Mobility Management Function, AMF, (308) associated with a relay UE 304, a first Nausf_UEAuthentication_ProseAuthenticate request message; providing (step 326, FIG. 3B), to a Unified Data Manager, UDM, (312) a Nudm_UEAuthentication_GetProseAv Request message that comprises a predefined Serving Network Name, SNN, associated with the 5G ProSe remote UE (302); receiving (step 326, FIG. 3B), from the UDM (312), an authentication vector, a cipher key, CK′, and an integrity key, IK′, that are based on ProSe parameters in the Nudm_UEAuthentication_GetProseAv request message and the predefined SNN; and providing (step 328, FIG. 3B), to the AMF (308) associated with the relay UE (304), an Nausf_UEAuthentication_ProSeAuthenticate Response that comprises an EAP-Request/AKA′-Challenge message based on the authentication vector, the CK′ and IK′.
Embodiment 2: The method of embodiment 1, further comprising: receiving (step 338, FIG. 3B) from the AMF (308) associated with the relay UE (304), a second Nausf_UEAuthentication_ProseAuthenticate request message comprising a EAP-Response/AKA′-Challenge from the 5G ProSe remote UE (302); and authenticating (step 338, FIG. 3B) the 5G ProSe remote UE (302) based on the EAP-Response/AKA′-Challenge.
Embodiment 3: The method of embodiment 2, further comprising: generating (step 340, 342, FIG. 3B) a Control Plane ProSe Remote User Key, CP-PRUK, identification, based on a routing indicator received from the UDM (312) in response to the Nudm_UEAuthentication_GetProseAv Request message.
Embodiment 4: An Authentication Server Function, AUSF, (310) for authenticating a 5G Proximity Service, ProSe, remote User Equipment, UE, the AUSF (310) comprising processing circuitry that is configured to cause the AUSF (310) to: receive (step 324, FIG. 3A), from an Access and Mobility Management Function, AMF, (308) associated with a relay UE (304), a first Nausf_UEAuthentication_ProseAuthenticate request message; provide, to a Unified Data Manager, UDM, (312) a Nudm_UEAuthentication_GetProseAv Request message that comprises a predefined Serving Network Name, SNN, associated with the 5G ProSe remote UE (302); receive, from the UDM (312), an authentication vector, a cipher key, CK′, and an integrity key, IK′, that are based on ProSe parameters in the Nudm_UEAuthentication_GetProseAv request message and the predefined SNN; and provide, to the AMF (308) associated with the relay UE (304), an Nausf_UEAuthentication_ProSeAuthenticate Response that comprises an EAP-Request/AKA′-Challenge message based on the authentication vector, the CK′ and IK′.
Embodiment 5: The AUSF (310) of embodiment 4, wherein the processing circuitry is further configured to: receive (step 338, FIG. 3B) from the AMF (308) associated with the relay UE (304), a second Nausf_UEAuthentication_ProseAuthenticate request message comprising a EAP-Response/AKA′-Challenge from the 5G ProSe remote UE (302); and authenticate (step 338, FIG. 3B) the 5G ProSe remote UE (302) based on the EAP-Response/AKA′-Challenge.
Embodiment 6: The AUSF (310) of embodiment 5, wherein the processing circuitry is further configured to: generate (step 340, 342, FIG. 3B) a Control Plane ProSe Remote User Key, CP-PRUK, identification, based on a routing indicator received from the UDM (312) in response to the Nudm_UEAuthentication_GetProseAv Request message.
Embodiment 7: A method implemented in a 5G Proximity Service, ProSe, remote User Equipment, UE, (302) for authenticating the 5G ProSe remote UE (302) comprising: providing (step 318, FIG. 3A), to a relay UE (304), a Direct Communication Request to establish a PC5 unicast link; receiving (step 330, FIG. 3B), from the relay UE (304), an EAP-Request/AKA′-Challenge message that was generated by an Authentication Server Function, AUSF, (310) of a remote network associated with the 5G ProSe remote UE (302); determining (step 316, FIG. 3A, step 332 FIG. 3B) a Serving Network Name, SNN, associated with the 5G ProSe remote UE; determining (step 332, FIG. 3B) a cipher key, CK′, and an integrity key, IK′, based on the SNN and the EAP-Request/AKA′-Challenge message; and providing (step 334, FIG. 3B) to the relay UE (304), a return EAP-Response/AKA′-Challenge message to facilitate authentication of the 5G ProSe remote UE (302) at the AUSF, (310) wherein the EAP-Response/AKA′-Challenge message is based on the CK′ and IK′.
Embodiment 8: The method of embodiment 7, wherein the determining the SNN further comprises: prior to providing the Direct Communication Request to the relay UE (304), triggering (step 316, FIG. 3A) a discovery procedure with the relay UE (304) to determine cell info associated with the relay UE (304); and determining the SNN based on the cell info.
Embodiment 9: The method of embodiment 8, further comprising: validating (step 332, FIG. 3B) the SNN with another SNN received from the AUSF (310) via an AT_KDF_INPUT of an Extensible Authentication Protocol, EAP, package.
Embodiment 10: The method of any of embodiments 8-9, wherein the cell info comprises one or more of a New Radio Cell Global Identity, NGCI, or Tracking Area Identity, TAI.
Embodiment 11: The method of embodiment 7, wherein the EAP-Request/AKA′-Challenge message comprises the SNN.
Embodiment 12: The method of embodiment 11, further comprising: validating (step 332, FIG. 3B) the SNN with another SNN received from the AUSF (310) via an AT_KDF_INPUT of an Extensible Authentication Protocol, EAP, package.
Embodiment 13: A 5G Proximity Service, ProSe, remote User Equipment, UE, (302) comprising processing circuitry that is configured to cause the 5G ProSe remote UE (302) to: provide (step 318, FIG. 3A), to a relay UE (304), a Direct Communication Request to establish a PC5 unicast link; receive (step 332, FIG. 3B), from the relay UE (304), an EAP-Request/AKA′-Challenge message that was generated by an Authentication Server Function, AUSF, (310) of a remote network associated with the 5G ProSe remote UE (302); determine (step 316, FIG. 3A, step 332 FIG. 3B) a Serving Network Name, SNN, associated with the 5G ProSe remote UE (302); determine (step 332, FIG. 3B) a cipher key, CK′, and an integrity key, IK′, based on the SNN and the EAP-Request/AKA′-Challenge message; and provide (step 334, FIG. 3B) to the relay UE (304), a return EAP-Response/AKA′-Challenge message to facilitate authentication of the 5G ProSe remote UE (302) at the AUSF, (310) wherein the EAP-Response/AKA′-Challenge message is based on the CK′ and IK′.
Embodiment 14: The 5G ProSe remote UE (302) of embodiment 13, wherein the processing circuitry is further configured to perform the methods of embodiment 8-12.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method implemented in a Fifth Generation, 5G, Proximity Service, ProSe, remote User Equipment, UE, for authenticating the 5G ProSe remote UE comprising:
receiving, from a relay UE, a serving network identifier associated with the relay UE;
receiving, from the relay UE, a challenge message that was generated by an Authentication Server Function, AUSF, associated with the 5G ProSe remote UE, wherein the challenge message comprises a Serving Network Name, SNN, associated with the relay UE;
validating the SNN associated with the relay UE with the serving network identifier associated with the relay UE;
determining a cipher key, CK′, and an integrity key, IK′, based on the SNN; and
providing to the relay UE, a response Challenge message to facilitate authentication of the 5G ProSe remote UE.

2. The method of claim 1, wherein the validating is in response to determining that a control plane-based security procedure is used for a Relay Service Code, RSC, for communication with relay UE.

3. The method of claim 2, wherein the determining that the control plane-based security procedure is used for the RSC for communication with the relay UE is based on an authentication request associated with the Challenge message.

4. The method of claim 1, wherein prior to receiving the serving network identifier from the relay UE, the method comprises:
providing, to a relay UE, a Direct Communication Request to establish a PC5 unicast link.

5. The method of claim 1, wherein the method further comprises:
triggering a discovery procedure with the relay UE to determine cell information associated with the relay UE.

6. The method of claim 5, wherein the cell info further comprises a Tracking Area Identity, TAI.

7. The method of claim 1, wherein the SNN comprised in the Challenge message comprises AT_KDF_INPUT of an Extensible Authentication Protocol, EAP, package.

8. The method of claim 1, wherein the Challenge message is an Extensible Authentication Protocol, EAP, Request/Authentication and Key Agreement, AKA′, Challenge message.

9. The method of claim 1, wherein the response Challenge message is an Extensible Authentication Protocol, EAP, Response/AKA′-Challenge message.

10. The method of claim 1, wherein the serving network identifier is at least one of Serving Network, SN, identifier, ID, information in a New Radio, NR, Cell Global Identity, NCGI, part of the NCGI, or associated with the NCGI.

11. The method of claim 1, wherein the validating is part of an Extensible Authentication Protocol Authentication and Key Agreement, EAP-AKA′, authentication procedure.

12. A Fifth Generation, 5G, Proximity Service, ProSe, remote User Equipment, UE, comprising processing circuitry that is configured to cause the 5G ProSe remote UE to:
receive, from a relay UE, serving network identifier associated with the relay UE;
receive, from the relay UE, a challenge message that was generated by an Authentication Server Function, AUSF, associated with the 5G ProSe remote UE, wherein the challenge message comprises a Serving Network Name, SNN, associated with the relay UE;
validate the SNN associated with the relay UE with the serving network identifier associated with the relay UE;
determine a cipher key, CK′, and an integrity key, IK′, based on the SNN; and
provide to the relay UE, a response Challenge message to facilitate authentication of the 5G ProSe remote UE′.

13. The 5G ProSe remote UE of claim 12, wherein the validating is in response to determining that a control plane-based security procedure is used for a Relay Service Code, RSC, for communication with relay UE.

14. The 5G ProSe remote UE of claim 13, wherein the determining that the control plane-based security procedure is used for the RSC for communication with the relay UE is based on an authentication request associated with the Challenge message.

15. The 5G ProSe remote UE of claim 12, wherein prior to receiving the serving network identifier from the relay UE, the processing circuitry is further configured to:
provide, to a relay UE, a Direct Communication Request to establish a PC5 unicast link.

16. The 5G ProSe remote UE of claim 12, wherein the processing circuitry is further configured to:
trigger a discovery procedure with the relay UE to determine cell information associated with the relay UE.

17. The 5G ProSe remote UE of claim 16, wherein the cell info further comprises a Tracking Area Identity, TAI.

18. The 5G ProSe remote UE of claim 12, wherein the SNN comprised in the Challenge message comprises AT_KDF_INPUT of an Extensible Authentication Protocol, EAP, package.

19. The 5G ProSe remote UE of claim 12, wherein the Challenge message is an Extensible Authentication Protocol, EAP, Request/Authentication and Key Agreement, AKA′, Challenge message.

20. The 5G ProSe remote UE of claim 12, wherein the response Challenge message is an Extensible Authentication Protocol, EAP, Response/AKA′-Challenge message.

21. The 5G ProSe remote UE of claim 12, wherein the serving network identifier is at least one of Serving Network, SN, identifier, ID, information in a New Radio, NR, Cell Global Identity, NCGI, part of the NCGI, or associated with the NCGI.

22. The 5G ProSe remote UE of claim 12, wherein the validating is part of an Extensible Authentication Protocol Authentication and Key Agreement, EAP-AKA′, authentication procedure.

23. (canceled)
